(19) United States
(12) Patent Application Publication
(10) Pub. No.: US 2026/0360783 A1
(43) Pub. Date: Nov. 12, 2026

(54) SYSTEM AND METHOD FOR CONVERTING AMMONIA TO POWER IN A BALANCING POWER SYSTEM

(71) Applicant: TOPSOE A/S, Kgs. Lyngby (DK)

(72) Inventor: Jes Nikolaj KNUDSEN, Birkerød (DK)

(73) Assignee: TOPSOE A/S, Kgs. Lyngby (DK)

(21) Appl. No.: 19/139,648

(22) PCT Filed: Dec. 20, 2023
(86) PCT No.: PCT/EP2023/086881

§ 371 Date: Jun. 16, 2025

(30) Foreign Application Priority Data
Dec. 22, 2022 (DK) PA202201199

(51) Int. Cl. H01M 8/0656; C01C 1/04; C25B 1/04; C25B 15/08; H01M 8/04082; H01M 8/04858; H01M 8/12; H01M 8/22; H02J 3/28; H02J 15/00

(52) U.S. Cl. CPC H01M 8/0656; C01C 1/0405; C25B 1/04; C25B 15/081; C25B 15/087; H01M 8/04201; H01M 8/04932; H01M 8/222; H02J 3/28; H01M 2008/1293; H02J 15/00

(57) ABSTRACT

A power balancing system and process is provided, in which an air separation unit (ASU) outputs a nitrogen-rich stream, a first electrolysis unit outputs a hydrogen rich-stream, and said nitrogen-rich stream and hydrogen rich-steam is converted in an ammonia synthesis unit to a first ammonia-rich stream. When additional electrical power is required, ammonia from the ammonia storage unit can be converted in an ammonia fuel cell and thereby result in power generation. The system and process allow excess electrical power to be converted into and stored as ammonia during periods of low energy demand, and used to generate electrical power when the energy demand is higher.

### TECHNICAL FIELD

The present invention relates to a power balancing system and process, in which an air separation unit (ASU) outputs a nitrogen-rich stream and a first electrolysis unit outputs a hydrogen-rich stream, and where an ammonia synthesis unit receives and converts said streams into a first ammonia-rich stream. An ammonia storage unit receives and stores the first ammonia-rich stream. When additional electrical power is required, an ammonia fuel cell receives and converts ammonia from the storage unit, a process resulting in power generation. The system and process allow excess electrical power to be converted into and stored as ammonia during periods of low energy demand, and for ammonia to be used to generate electrical power when demand for energy is higher.

### BACKGROUND

In the increasing rollout of renewable power generation, account needs to be taken for the variability in power production from such sources, which can occur hourly, daily or seasonally. Large-scale battery arrays are being commercially developed as one solution to this problem, in an attempt to balance or “level out” the supply and demand curves.

A system for balancing the power generation from renewable energy and the grid consumption is described in U.S. Pat. No. 10,323,544. In U.S. Pat. No. 10,323,544, power can be generated by:
a) cracking of NH₃ to H₂ and N₂,
b) combustion of H₂/N₂, possibly in a gas turbine (if combustion takes place in a gas turbine, electrical power is generated),
c) conversion of flue gas/gas turbine exhaust gas sensible heat to power in e.g. a steam Rankine cycle or organic Rankine cycle.

At the same time as balancing the output from renewable power, there is a focus on reducing output of CO₂ and other waste gases in downstream processes. Elimination of combustion and cracking steps could also lead to reduced heat requirement, and/or the need to re-use heated streams elsewhere in a plant. There is also a need to increase power generation, while reducing plot area and utilities' consumption. It would also be advantageous if power balancing could be combined with useful electrochemical synthesis processes (“power-to-X”).

These goals are addressed by the present technology.

### SUMMARY

The present idea is to produce ammonia (NH₃) from renewable power (wind, solar, etc.) when power is in excess. NH₃ is produced from N₂ provided from an air separation unit (ASU) and H₂ provided from electrolysis, where the power for both the air separation and the electrolysis is supplied by renewable power. The ammonia can easily be stored in an ammonia storage unit and converted to power using an ammonia fuel cell, when renewable power sources are insufficient to supply the power grid.

So, in a first aspect the present invention relates to a power balancing system, said system comprising:
an air feed,
a first water-rich feed,
a supply of renewable electricity,
an air separation unit, ASU,
a first electrolysis unit,
an ammonia loop,
an ammonia storage unit,
an ammonia fuel cell,
wherein,
the air separation unit, ASU, is arranged to receive said air feed and a first portion of said supply of renewable electricity, and to output a nitrogen-rich stream;
the first electrolysis unit is arranged to receive said first water-rich feed and a second portion of said supply of renewable electricity, and to output a hydrogen-rich stream;
the ammonia loop being arranged to receive the nitrogen-rich stream from the ASU and the hydrogen-rich stream from the first electrolysis unit and output a first ammonia-rich stream;
the ammonia storage unit is arranged to receive and store at least a portion of the first ammonia-rich stream; and output a second ammonia-rich stream; the ammonia fuel cell is arranged to receive at least a portion of the second ammonia-rich stream from the ammonia storage unit and to output an electrical power stream;
wherein the power balancing system is arranged to feed the electrical power stream from the ammonia fuel cell to a power grid.

A process for balancing electrical power in a power balancing system as described herein is also provided.

Further details of the technology are provided in the following claims, description text and the appended figures.

### LEGENDS

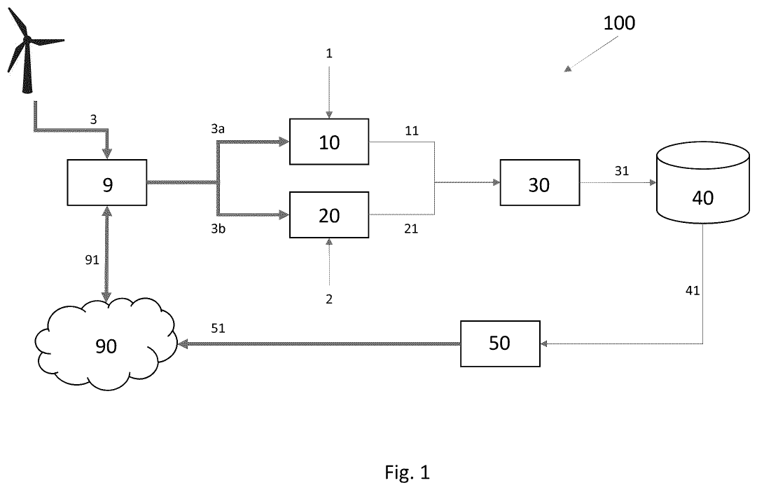

FIG. 1 shows a schematic layout of a power balancing system according to one embodiment of the invention.

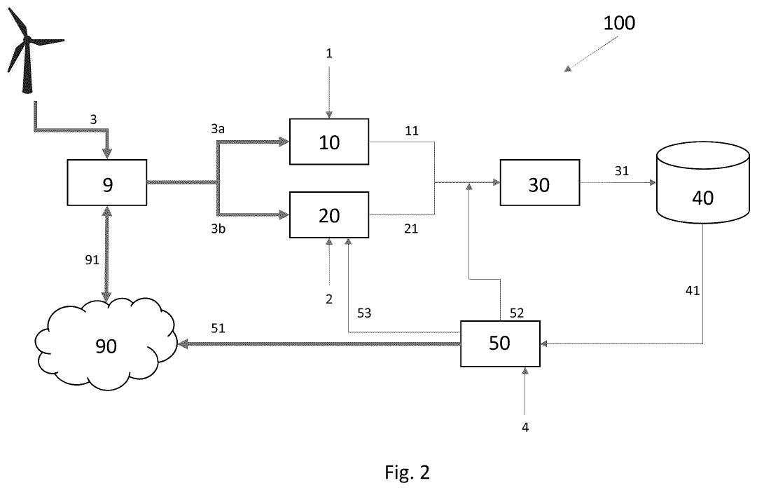

FIG. 2 shows a schematic layout of a power balancing system according to a further embodiment of the invention

### DETAILED DISCLOSURE

A power balancing system is provided. The system allows excess electrical power to be converted into and stored as ammonia during periods of low energy demand, and for ammonia to be used to generate electrical power when the energy demand is higher.

When a stream is described as “rich” in a certain component, it is generally meant that the majority (i.e. over 50% by volume) of the stream consists of said component. Depending on the stream, the proportion of the component may be higher.

In general terms, the system comprises:
an air feed,
a first water-rich feed,
a supply of renewable electricity,
an air separation unit, ASU,
a first electrolysis unit,
an ammonia loop,
an ammonia storage unit, and
an ammonia fuel cell.

A supply of renewable electricity is required. Renewable electricity may come from solar, wind, wave, or tidal energy, and is typically intermittent. A first portion of the supply of renewable electricity is provided to the air separation unit and a second portion of the supply of renewable electricity is provided to the first electrolysis unit.

The air feed comprises approx. 78 mole % nitrogen. The air separation unit, ASU, is arranged to receive the air feed and the first portion of said supply of renewable electricity, and to output a nitrogen-rich stream. The air separation unit suitably comprises a compressor unit and one or more pressure swing adsorption (PSA) units. Said compressor unit may be arranged to compress the air feed using the renewable electricity. The PSA is arranged to receive the compressed air and output the nitrogen-rich stream and an off-gas stream comprising oxygen and noble gases such as argon. The nitrogen-rich steam produced from the ASU is suitably high purity (e.g. over 98%, or over 99%) nitrogen.

Membrane separation or cryogenic separation may also be used as components of the ASU.

The water-rich feed is suitably high purity (e.g. over 99%, or over 99.999%) water or steam. The first electrolysis unit (which is preferably one or more SOECs) is arranged to receive the first water-rich feed and a second portion of the supply of renewable electricity, and to output a hydrogen-rich stream, by electrolysis of the first water-rich feed. The hydrogen-rich stream produced by the first electrolysis unit is suitably high purity (e.g. over 98%, or over 99%) hydrogen.

The ammonia synthesis unit (also called a “ammonia loop”) is arranged to receive the nitrogen-rich stream from the ASU and the hydrogen-rich stream from the first electrolysis unit and output a first ammonia-rich stream. The skilled person knows how to design and implement an ammonia synthesis unit to produce ammonia from N₂ and H₂. Said ammonia synthesis unit may comprise a catalyst such that H₂ is catalytically reacted with N₂. The first ammonia-rich stream is suitably a gaseous NH₃ stream of high purity (e.g. over 98%, or over 99%) ammonia. Conversion in the ammonia loop is typically below 30%. After condensation of the main part of the produced NH₃, the remaining gases can be added to more syngas (make-up gas) then looped back to the ammonia synthesis unit.

The ammonia storage unit is arranged to receive and store at least a portion of the first ammonia-rich stream; and output a second ammonia-rich stream. First and second ammonia-rich streams are essentially identical in composition, but may vary in terms of their physical properties, e.g. temperature or pressure. Ammonia storage typically takes place in large, pressurised tanks kept at ambient temperature.

The ammonia fuel cell is arranged to receive at least a portion of the second ammonia-rich stream from the ammonia storage unit and to output an electrical power stream. Fuel cells which convert ammonia to electrical power are known. In one aspect, the ammonia fuel cell comprises one or more solid oxide fuel cell (SOFCs) such as one or more oxygen ion conducting SOFCs (SOFC-Os), one or more proton-conducting SOFCs (PC-SOFCs), one or more direct ammonia fuels cells (DAFCs), preferably said ammonia fuel cell comprises one or more SOFC-Os. In one aspect, said system may further comprise an oxidant feed, wherein said oxidant feed is an oxygen-rich feed such as high purity (>98% or 99%) oxygen feed or an air feed, or enriched air (O₂>21%) and said feed is arranged to be fed to the ammonia fuel cell. Multiple cells may be combined into SOFC stacks, and multiple stacks may in turn be combined into an SOFC plant.

In embodiments the ammonia fuel cell comprises one or more SOFCs. A solid oxide fuel cell (SOFC) is an electrochemical conversion device having two compartments (an anode side and a cathode side) divided by an electrolyte material made of a solid oxide or a ceramic electrolyte. The oxidant feed may suitably be a high purity oxygen-rich feed (>98% such as 99%) or an air feed, or enriched air (O₂>21%) , which enters the cathode side of the ammonia fuel cell. The second ammonia-rich stream may enter the anode side (fuel side), wherein the (2)NH₃ is split into (1)N₂ and (3)H₂, followed by H₂ undergoing electrochemical oxidation, which results in generation of electrical power. In one embodiment the ammonia fuel cell comprises one or more SOF-O. Within said embodiment, the electrons are emitted at the interaction surface of H₂ and the negatively charge O²⁻ ions, and said electrons flow through an external circuit. The flow of electrons enables electrons to reach the cathodic side of the fuel cell, where the O₂ accept the electrons and get reduced to O²⁻ ions, which migrate through the solid oxide electrolyte to reach the anodic side of the cell. For SOFC-O the electrolyte material may be yttria-stabilized zirconia (YSZ) or samarium-doped ceria (SDC) materials. The output from the anode side of the SOFC-O may comprise NH₃, N₂, H₂ and H₂O. In other embodiments, the ammonia fuel cell comprises one or more PC-SOFCs or one or more DAFCs. Within embodiments comprising PC-SOFCs or DAFCs, it is instead protons which migrate within the electrolyte, which means that water (H₂O) is formed at the cathode side, where the protons encounter the oxygen. In this way, applying an ammonia fuel cell generates a continuous flow of electrons and ions as a continuous feed of ammonia and oxidant is supplied to the cell.

Applying an ammonia fuel cell is highly power efficient. In addition, the use results in a smaller plot area, lower capital expenditures (CAPEX) and lower consumption of utilities (such as cooling water) compared to conventional solutions. In this way, by using one or more ammonia fuel cells such as an SOFC plant instead of a NH₃ cracker, gas turbine and/or Rankine cycle, the efficiency of power generation is increased and also the plot area and utilities' consumption are reduced.

By-products from of the ammonia fuel cell may comprise at least one nitrogen-rich stream and at least one water-rich stream. Said by-product streams provided from the ammonia fuel cell may be recycled into relevant units.

In one aspect, the ammonia fuel cell is arranged to provide a second nitrogen-rich stream and the ammonia loop is arranged to receive at least a portion of said second nitrogen-rich stream from the ammonia fuel cell as a recycle stream, optionally in admixture with the nitrogen-rich stream from the ASU. In one aspect, the system further comprises a nitrogen storage unit arranged to receive and store at least a portion of said second nitrogen-rich stream from the ammonia fuel cell and output a third nitrogen-rich stream, wherein the ammonia loop is arranged to receive at least a portion of said third nitrogen-rich stream as a recycle stream, optionally in admixture with the nitrogen-rich stream from the ASU. The second and/or third nitrogen-rich stream from the ammonia fuel cell is high purity (e.g. over 95%, over 98%, or over 99%) nitrogen. In this way, said aspect allow for the recycle of nitrogen which lowers the requirement for the air separation units. In addition, having the nitrogen storage unit arranged thus that the nitrogen-rich stream may be provide directly to the ammonia loop without delay, enables more efficient production of ammonia when renewable power is in excess as the ASU may be in full effect under said conditions.

In one aspect, the ammonia fuel cell is arranged to provide a second water-rich stream and the first electrolysis unit is arranged to receive at least a portion of said second water-rich stream from the ammonia fuel cell as a recycle stream, optionally in admixture with the first water-rich stream. In one aspect, the system further comprises a water storage unit arranged to receive and store at least a portion of said second water-rich stream from the ammonia fuel cell and output a third water-rich stream, wherein the first electrolysis unit is arranged to receive at least a portion of said third water-rich stream, as a recycle stream, optionally in admixture with the first water-rich stream. The second and/or third water-rich stream from the ammonia fuel cell is suitably high purity (e.g. over 98%, or over 99.999%) water or steam and excess ammonia. In this way, said aspect allows for recycle of water, which is already of high purity, hence lowers the volume of first water-rich feed needed to supply the first electrolysis unit. In addition, having the water storage unit arranged thus that the water-rich stream (already high purity) may be provide directly to the first electrolysis unit, enables further flexibility in supply of water.

In one embodiment, the system comprises both the nitrogen storage unit and the water storage unit, and the ammonia loop is arranged to receive at least a portion of the third nitrogen-rich stream from said nitrogen storage unit as a recycle stream and the first electrolysis unit is arranged to receive at least a portion of the third water-rich stream from the water storage unit as a recycle stream. Having said storage units arrange such that a recycle water-rich stream and a recycle nitrogen-rich stream of high purity is available for use enables flexibility for the power balancing system, thus that said system can produce ammonia efficiently when renewable power is in excess.

The power balancing system is arranged to feed the electrical power stream from the ammonia fuel cell to a power grid. Feeding electrical power back to the grid allows power to be balanced via ammonia production, storage and conversion back into electricity. In aspects, the electrical power stream output from the ammonia fuel cell is arranged to increase in response to a drop in the supply of renewable electricity. More specifically, the electrical power stream output from the ammonia fuel cell may be arranged to increase in response to a drop in the supply of renewable electricity to the ASU and/or the first electrolysis unit. In one aspect, an increase in the electrical power stream output from the ammonia fuel cell is provided by increased output of the second ammonia-rich stream from said ammonia storage unit. In this way, the power balancing system is arranged to use ammonia to generate electrical power when the demand for energy is higher than what is provided from renewable power.

The system may further comprise a power regulating section, arranged between the supply of renewable energy and the first electrolysis unit. The power regulating section is arranged to send any excess electrical power from the supply of renewable energy and the first electrolysis unit, e.g. when supply outstrips grid demand.

A process for balancing electrical power in a power balancing system is also provided. In general terms, the process comprises the steps of:
supplying the air feed and a first portion of the supply of renewable electricity to the air separation unit, ASU, and outputting a nitrogen-rich stream;
supplying the water-rich feed and a second portion of said supply of renewable electricity, to the first electrolysis unit and outputting a hydrogen-rich stream;
supplying the nitrogen-rich stream from the ASU and the hydrogen-rich stream from the first electrolysis unit to the ammonia loop and outputting a first ammonia-rich stream;
supplying at least a portion of the first ammonia-rich stream to the ammonia storage unit, and outputting a second ammonia-rich stream;
supplying at least a portion of the second ammonia-rich stream from the ammonia storage unit to the ammonia fuel cell and outputting an electrical power stream;
feeding the electrical power stream from the ammonia fuel cell to a power grid.

All details of the system of the invention are relevant to the process of the invention, mutatis mutandis. For instance, the process suitably comprises a step of increasing the electrical power stream fed from the ammonia fuel cell increases in response to a drop in the supply of renewable electricity e.g. to the ASU and/or the first electrolysis unit. As above, an increase in the electrical power stream may be provided by increased output of the second ammonia-rich stream from said ammonia storage unit.

In one aspect, said system comprises an oxidant feed and one or more SOFCs within the ammonia fuel cell and said process comprises feeding the oxidant feed to the ammonia fuel cell, where said oxidant feed is an oxygen-rich feed such as a high purity (>98% or 99%) oxygen feed, or enriched air (O₂>21%) , or an air feed.

In aspects, said processes comprises providing a second nitrogen-rich stream from said ammonia fuel cell and feeding at least a portion of said second nitrogen-rich stream to the ammonia loop as a recycle stream, optionally in admixture with the nitrogen-rich stream from the ASU. Additionally, or alternatively, the process may comprises providing a second nitrogen-rich stream from said ammonia fuel cell and feeding at least a portion of said second nitrogen-rich stream to a nitrogen storage unit, and providing a third nitrogen-rich stream from said nitrogen storage unit and feeding at least a portion of said third nitrogen-rich stream to the ammonia loop as a recycle stream, optionally in admixture with the nitrogen-rich stream from the ASU.

In a particular aspect, said system comprises the nitrogen storage unit and said process comprises feeding at least a portion of said third nitrogen-rich stream from the nitrogen storage unit to the ammonia loop, when the first portion of said supply of renewable electricity is above a predetermined threshold value. The threshold value will be the power consumption for the air separation unit, ASU, the said first electrolysis unit, and the ammonia loop, all operating at the minimum capacity. The minimum capacity will be <30% or <10% of maximum capacity. Said process step enables an optimised ammonia production when renewable power is in excess compared to the energy demand.

In aspects, said process comprises providing the second water-rich stream from said ammonia fuel cell and feeding at least a portion of said second water-rich stream to the first electrolysis unit as a recycle stream, optionally in admixture with the first water-rich stream. Additionally and/or alternatively, the process may comprises providing the second water-rich stream from said ammonia fuel cell and feeding at least a portion of said second water-rich stream to the water storage unit, and providing a third water-rich stream from said water storage unit and feeding at least a portion of said third water-rich stream to the first electrolysis unit as a recycle stream, optionally in admixture with the first water-rich stream.

In a particular aspect, said process comprises feeding at least a portion of said third water-rich stream from the water storage unit to the first electrolysis unit, when the second portion of said supply of renewable electricity is above a predetermined threshold value.

### Specific Embodiments

A power regulating section (9) receives a supply of renewable electricity (3) and exchanges at least a portion of the renewable electricity (91) with the power grid (90) such that the required power is made available in the grid for consumers. The power regulating section (9) sends any excess electrical power to the power balancing system (100), wherein the power balancing system (100) in a first specific embodiment is described as follows (illustrated in FIG. 1):

An air separation unit, ASU (10) receives an air feed (1) and a first portion (3a) of supply of renewable electricity (3) and outputs a nitrogen-rich stream (11). A first electrolysis unit (20) receives a first water-rich feed (2) and a second portion (3b) of said supply of renewable electricity (3), and outputs a hydrogen-rich stream (21). The nitrogen-rich stream (11) and hydrogen-rich stream (21) is then fed to an ammonia loop (30), which output a first ammonia-rich stream (31). An ammonia storage unit (40) receives and stores the first ammonia-rich stream (31). On demand, the ammonia storage unit (40) outputs a second ammonia-rich stream (41), which is then received by an ammonia fuel cell (50). The ammonia fuel cell (50) outputs an electrical power stream (51), which is fed to the power grid (90). An increased output of the second ammonia-rich stream (41) from said ammonia storage unit (40) may be induced in response to a drop in the supply of renewable electricity (3). In this way, when renewable power comes in deficit compared to the power consumption in grid, power can be produced from ammonia by generating power directly from ammonia in a fuel cell.

In one embodiment, illustrated in FIG. 2, the power balancing system (100) is further developed. In addition to what is described in the first specific embodiment, the ammonia fuel cell (50) receives an oxidant feed (4) and outputs a second nitrogen-rich stream (52) and a second water-rich stream (53) in addition to the electrical power stream (51). The ammonia loop (30) receives at least a portion of the second nitrogen-rich stream (52) from said ammonia fuel cell (50) as a recycle stream, optionally in admixture with the nitrogen-rich stream (11) from the ASU (10). The first electrolysis unit (20) receives at least a portion of the second water-rich stream (53) from said ammonia fuel cell (50) as a recycle stream, optionally in admixture with the first water-rich stream (2).

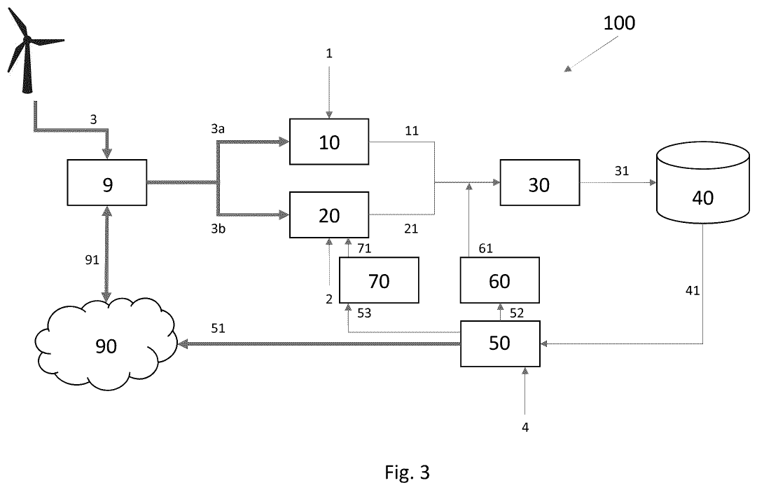

In one embodiment, illustrated in FIG. 3, the power balancing system (100) further comprises a nitrogen storage unit (60) and a water storage unit (70). The nitrogen storage unit (60) receives at least a portion of the second nitrogen-rich stream (52) from said ammonia fuel cell (50) and outputs, on demand, a third nitrogen-rich stream (61), which is fed to the ammonia loop (30) as a recycle stream, optionally in admixture with the nitrogen-rich stream (11) from the ASU (10). Similarly, the water storage unit (70) receives at least a portion of the second water-rich stream (53) from said ammonia fuel cell (50) and outputs, on demand, a third water-rich stream (71), which is fed to the first electrolysis unit (20) as a recycle stream, optionally in admixture with the first water-rich stream (2).

While the invention has been described with reference to a number of embodiments and aspects, the overall scope of the invention is defined in the appended claims. The skilled person may combine embodiments and aspects as required, within the scope of the invention. All documents mentioned herein are incorporated by reference.

1. A power balancing system said system comprising:
an air feed,
a first water-rich feed,
a supply of renewable electricity,
an air separation unit, ASU,
a first electrolysis unit,
an ammonia loop,
an ammonia storage unit,
an ammonia fuel cell,
wherein,
the air separation unit, ASU is arranged to receive said air feed and a first portion of said supply of renewable electricity, and to output a nitrogen-rich stream;
the first electrolysis unit is arranged to receive said first water-rich feed and a second portion of said supply of renewable electricity, and to output a hydrogen-rich stream;
the ammonia loop is arranged to receive the nitrogen-rich stream from the ASU and the hydrogen-rich stream from the first electrolysis unit and output a first ammonia-rich stream;
the ammonia storage unit is arranged to receive and store at least a portion of the first ammonia-rich stream; and output a second ammonia-rich stream;
the ammonia fuel cell is arranged to receive at least a portion of the second ammonia-rich stream from the ammonia storage unit and to output an electrical power stream;
wherein the power balancing system is arranged to feed the electrical power stream from the ammonia fuel cell to a power grid.

2. The system according to claim 1, wherein the electrical power stream output from the ammonia fuel cell is arranged to increase in response to a drop in the supply of renewable electricity.

3. The system according to claim 2, wherein the electrical power stream output from the ammonia fuel cell is arranged to increase in response to a drop in the supply of renewable electricity to the ASU and/or the first electrolysis unit.

4. The system according to claim 2, wherein an increase in the electrical power stream output from the ammonia fuel cell is provided by increased output of the second ammonia-rich stream from said ammonia storage unit.

5. The system according to claim 1, wherein the ammonia fuel cell comprises one or more solid oxide fuel cell, one or more proton-conducting SOFCs, one or more direct ammonia fuels cells.

6. The system according to claim 5, wherein said system further comprises an oxidant feed, wherein said oxidant feed is an oxygen-rich feed or an air feed, and said feed is arranged to be fed to the ammonia fuel cell.

7. The system according to claim 1, wherein the ammonia fuel cell is arranged to provide a second nitrogen-rich stream and the ammonia loop is arranged to receive at least a portion of said second nitrogen-rich stream from the ammonia fuel cell as a recycle stream, optionally in admixture with the nitrogen-rich stream from the ASU.

8. The system according to claim 1, wherein the system further comprises a nitrogen storage unit arranged to receive and store at least a portion of said second nitrogen-rich stream from the ammonia fuel cell and output a third nitrogen-rich stream, wherein the ammonia loop is arranged to receive at least a portion of said third nitrogen-rich stream as a recycle stream, optionally in admixture with the nitrogen-rich stream from the ASU.

9. The system according to claim 1, wherein the ammonia fuel cell is arranged to provide a second water-rich stream and the first electrolysis unit is arranged to receive at least a portion of said second water-rich stream from the ammonia fuel cell as a recycle stream, optionally in admixture with the first water-rich stream.

10. The system according to claim 1, wherein the system further comprises a water storage unit arranged to receive and store at least a portion of said second water-rich stream from the ammonia fuel cell and output a third water-rich stream, wherein the first electrolysis unit is arranged to receive at least a portion of said third water-rich stream, as a recycle stream, optionally in admixture with the first water-rich stream.

11. A process for balancing electrical power in the power balancing system according to claim 1, said process comprising the steps of:
supplying the air feed and a first portion of the supply of renewable electricity the air separation unit, ASU, and outputting a nitrogen-rich stream;
supplying the water-rich feed and a second portion of said supply of renewable electricity, to the first electrolysis unit and outputting a hydrogen-rich stream;
supplying the nitrogen-rich stream from the ASU and the hydrogen-rich stream from the first electrolysis unit to the ammonia loop and outputting a first ammonia-rich stream;
supplying at least a portion of the first ammonia-rich stream to the ammonia storage unit, and outputting a second ammonia-rich stream;
supplying at least a portion of the second ammonia-rich stream from the ammonia storage unit to the ammonia fuel cell and outputting an electrical power stream;
feeding the electrical power stream from the ammonia fuel cell to a power grid.

12. The process according to claim 11, wherein the electrical power stream fed from the ammonia fuel cell increases in response to a drop in the supply of renewable electricity e.g. to the ASU and/or the first electrolysis unit.

13. The process according to claim 11, wherein an increase in the electrical power stream is provided by increased output of the second ammonia-rich stream from said ammonia storage unit.

14. The process according to claim 11, wherein said system comprises an oxidant feed and one or more SOFCs within the ammonia fuel cell and wherein said process comprises feeding the oxidant feed to the ammonia fuel cell, where said oxidant feed is an oxygen-rich feed or an air feed.

15. The process according to claim 11, wherein said process comprises providing a second nitrogen-rich stream from said ammonia fuel cell and feeding at least a portion of said second nitrogen-rich stream to the ammonia loop as a recycle stream, optionally in admixture with the nitrogen-rich stream from the ASU.

16. The process according to claim 11, wherein said process comprises providing a second nitrogen-rich stream from said ammonia fuel cell and feeding at least a portion of said second nitrogen-rich stream to a nitrogen storage unit, and providing a third nitrogen-rich stream from said nitrogen storage unit and feeding at least a portion of said third nitrogen-rich stream to the ammonia loop as a recycle stream, optionally in admixture with the nitrogen-rich stream from the ASU.

17. The process according to claim 16, wherein said process comprises feeding at least a portion of said third nitrogen-rich stream from the nitrogen storage unit to the ammonia loop, when the first portion of said supply of renewable electricity is above a predetermined threshold value.

18. The process according to claim 11, wherein said process comprises providing the second water-rich stream from said ammonia fuel cell and feeding at least a portion of said second water-rich stream to the first electrolysis unit as a recycle stream, optionally in admixture with the first water-rich stream.

19. The process according to claim 11, wherein said process comprises providing the second water-rich stream from said ammonia fuel cell and feeding at least a portion of said second water-rich stream to the water storage unit, and providing a third water-rich stream from said water storage unit and feeding at least a portion of said third water-rich stream to the first electrolysis unit as a recycle stream, optionally in admixture with the first water-rich stream.

20. The process according to claim 19, wherein said process comprises feeding at least a portion of said third water-rich stream from the water storage unit to the first electrolysis unit, when the second portion of said supply of renewable electricity is above a predetermined threshold value.
